(19) United States
(12) Patent Application Publication
(10) Pub. No.: US 2017/0150131 A1
(43) Pub. Date: May 25, 2017

(54) AUTOSTEREOSCOPIC DISPLAY SYSTEM

(71) Applicant: KONINKLIJKE PHILIPS N.V., EINDHOVEN (NL)

(72) Inventors: EIBERT GERJAN VAN PUTTEN, EINDHOVEN (NL); MARK THOMAS JOHNSON, EINDHOVEN (NL); BART KROON, EINDHOVEN (NL)

(21) Appl. No.: 15/316,280

(22) PCT Filed: Jun. 19, 2015
(86) PCT No.: PCT/EP2015/063785

§ 371 Date: Dec. 5, 2016

(30) Foreign Application Priority Data
Jun. 27, 2014 (EP) 14174652.9

(51) Int. Cl. H04N 13/04; G02B 27/22

(52) U.S. Cl. CPC H04N 13/0404; H04N 13/0415; H04N 13/0422; G02B 27/2214; G09G 3/3611

(57) ABSTRACT

An autostereoscopic display system (240) arranged to display an autostereoscopic image, the display system comprising a display panel (400, 500) comprising multiple sub-pixels. The multiple sub-areas of a sub-pixel comprising a high-intensity sub-area, wherein the high-intensity sub-area is arranged to provide light of a higher intensity than the other sub-areas in the multiple sub-areas of the sub-pixel for at least one image value received in the sub-pixel. The high-intensity sub-area may be arranged in the sub-pixel to reduce banding, inter alia, by splitting the multiple sub-areas along a direction parallel to the direction of the columns.

### FIELD OF THE INVENTION

The invention relates to an autostereoscopic display system and to a display panel.

### BACKGROUND

A known autostereoscopic display device comprises a two-dimensional liquid crystal display panel having a row and column array of display pixels acting as an image forming means to produce a display. An array of elongated lenses extending parallel to one another overlies the display pixel array and acts as a view forming means. These are known as “lenticular lenses”. Outputs from the display pixels are projected through these lenticular lenses, which function to modify the directions of the outputs.

The lenticular lenses are provided as a sheet of lens elements, each of which comprises an elongate partly-cylindrical (e.g. semi-cylindrical) lens element. The lenticular lenses extend in the column direction of the display panel, with each lenticular lens overlying a respective group of two or more adjacent columns of display sub-pixels.

Each lenticular lens can be associated with two columns of display sub-pixels to enable a user to observe a single stereoscopic image. Instead, each lenticular lens can be associated with a group of three or more adjacent display sub-pixels in the row direction. Corresponding columns of display sub-pixels in each group are arranged appropriately to provide a vertical slice from a respective two dimensional sub-image. As a user's head is moved from left to right a series of successive, different, stereoscopic views are observed creating, for example, a look-around impression.

The above described autostereoscopic display device produces a display having good levels of brightness. However, several problems are associated with the device. The views projected by the lenticular sheet are separated by dark zones caused by “imaging” of the non-emitting black matrix which typically defines the display sub-pixel array. These dark zones are readily observed by a user as brightness non-uniformities in the form of dark vertical bands spaced across the display. The bands move across the display as the user moves from left to right and the pitch of the bands changes as the user moves towards or away from the display. Another problem is that the vertically aligned lens results in a reduction in resolution in the horizontal direction only, while the resolution in the vertical direction is not altered. Thus the resolutions in horizontal and vertical direction are not balanced ideally.

Both of these issues can be at least partly addressed by slanting the lenticular lenses at an acute angle relative to the column direction of the display pixel array. WO2010/070564 discloses an arrangement in which the lens pitch and lens slant are selected in such a way as to provide an improved pixel layout in the views created by the lenticular array, in terms of spacing of color sub-pixels, and color uniformity.

For many displays the transmission of light through a sub-pixel is viewing-angle dependent. This occurs especially in liquid crystal type displays. This results in a low color performance and even grayscale inversion.

### SUMMARY OF THE INVENTION

An autostereoscopic display system is provided, arranged to display an autostereoscopic image. The display system comprises a display panel and a view forming system.

The display panel comprises multiple sub-pixels arranged in rows and columns, the sub-pixels being arranged to provide light according to an image value received in the sub-pixel. The sub-pixels comprise multiple sub-areas, each sub-area of the sub-pixel being arranged to provide light according to the image value received in the sub-pixel.

The multiple sub-areas comprising a high-intensity sub-area, wherein the high-intensity sub-area is arranged to provide light of a higher intensity than the other sub-areas in the multiple sub-areas of the sub-pixel for at least one image value received in the sub-pixel. Thus at least two of the multiple sub-areas in a sub-pixel are arranged to provide light of a different intensity for at least one image value received in the sub-pixel.

The resulting intensity of the sub-pixel in response to an image value is an average of the intensities of the sub-areas. Accordingly, for a given resulting average of the intensity, some sub-areas have a higher intensity, e.g., closer to full white, whereas others have a lower intensity, e.g., closer to black. Accordingly, the transmission of light through a sub-pixel is less viewing-angle dependent.

In other words, there exists an image value, which causes one sub-area to provide light of a different intensity than another sub-area in the same sub-pixels. This means that the two sub-areas have a different tone response, also known as the tone response curve. The tone response indicates the intensity of the provided light as a function of the received image value.

In an embodiment, the high-intensity sub-area and another sub-area of the multiple sub-areas in a sub-pixel are arranged to provide light to a different intensity when receiving an image value that indicates a midpoint in an image value range; the so-called 50% grey point. In an embodiment, said different intensity is substantially different, e.g., at least 10%, or even at least 50% different. In that embodiment, there is thus at least 50% different light intensity at the 50% image value for two sub-areas in the same sub-pixel.

The view forming system comprises a group of lens elements. The lens elements are arranged with respect to the multiple sub-pixels to direct light from the sub-pixels into different angular directions to form the autostereoscopic image. The view forming system may comprise a lenticular, e.g., a sheet comprising a plurality of elongated lenses. The lenticular may be applied under a slant with the column direction of the display panel. The lens element may be micro lenses, e.g. spherical micro lenses.

Although sub-pixel areas reduce viewing-angle dependency, they may cause severe banding in auto-stereoscopic displays; in particular, in auto-stereoscopic displays comprising a lenticular. The banding problem with autostereoscopic displays may be defined as an undesired intensity variation due to the angle and position dependent magnification of the black matrix by the lenticular lens. For monolithic displays, i.e., each sub-pixel having a single sub-area, banding is also an issue, but which has been largely resolved through an appropriate selection of parameters, in particular the pitch and slant. Thus an additional problem to be addressed is to reduce banding for autostereoscopic displays in which sub-pixels have multiple sub-areas.

In an embodiment, the sub-pixels are split in the multiple sub-areas along a direction parallel to the direction of the columns (or rows). The multiple sub-areas of each sub-pixel comprise a high-intensity sub-area in which the light intensity in response to an image value representing a midpoint of an image value range is maximum. Along the sub-pixels of the column (or rows) of the display panel the low-gamma sub-areas are at the same position in the sub-pixel, the low-gamma sub-areas thus forming a low-gamma sub-area line extending in the column of sub-pixels. A low-gamma sub-area is thus directly adjacent to a low-gamma area in a sub-pixel that is directly adjacent, either in the same row or same column. In this manner the low-gamma sub-areas form a continuous band across the display panel, which reduces banding. In an embodiment, for at least two adjacent sub-pixels in a row their high-intensity sub-areas have the same position in the sub-pixel relative to the other sub-areas in the sub-pixels.

In an embodiment, the multiple sub-areas of a sub-pixel comprise at least three different sub-areas. It was found that increasing the number of sub-areas to more than 2 will decrease banding regardless of the pattern in which the sub-areas are laid out; even in a checkerboard arrangement.

An aspect of the invention concerns a method of displaying an autostereoscopic image.

The autostereoscopic display described herein may be applied in a wide range of practical applications. Such practical applications include scientific and medical visualization of complex 3D structures, and remote manipulation of robots, computer games, and advertising. Autostereoscopic displays are also suitable for simulators, such as flight simulators.

### BRIEF DESCRIPTION OF THE DRAWINGS

These and other aspects of the invention are apparent from and will be elucidated with reference to the embodiments described hereinafter. In the drawings,

FIG. 1a is a schematic perspective view of an autostereoscopic display device,

FIG. 1b is a schematic cross sectional view of the display device shown in FIG. 1a,

FIG. 1c shows parameters relating to the configuration of the 2D display panel and a projected 3D view,

FIG. 1d shows a detail from FIG. 1b,

FIG. 2a schematically shows a sub-pixel 200,

FIG. 2b schematically shows a sub-pixel 210,

FIG. 2c schematically shows a display system 240,

FIG. 2d schematically shows in the form of a flow chart an autostereoscopic display method 250,

FIG. 3a schematically shows a sub-pixel 300,

FIG. 3b schematically shows a sub-pixel 310,

FIG. 3c schematically shows possible tone response curves,

FIG. 3d schematically shows a possible circuit for a sub-pixel,

FIG. 3e schematically shows a sub-pixel 320,

FIG. 3f schematically shows a sub-pixel 330,

FIG. 3g schematically shows a sub-pixel 340,

FIG. 3h schematically shows a sub-pixel 350,

FIG. 3i schematically shows possible tone response curves,

FIG. 3j schematically shows possible tone response curves,

FIG. 4a schematically shows part of display panel 400,

FIG. 4b schematically shows the amount of visible banding in panel 400,

FIG. 5a schematically shows part of display panel 500,

FIG. 5b schematically shows the amount of visible banding in panel 500,

FIG. 6a schematically shows sub-pixels horizontally split into two sub-areas,

FIG. 6b schematically shows the pattern of panel 500,

FIG. 6c schematically shows a checkerboard design,

FIG. 6d schematically shows the pattern of panel 400,

FIG. 6e schematically shows expected banding for different sub-pixel area designs as a function of lens design,

FIG. 7a schematically shows checkerboard patterns with a varying number of sub-pixel area rows and two different sub-pixel aspect ratios,

FIG. 7b schematically shows the corresponding expected banding for different sub-pixel area designs in the N=1, C=3 region,

FIG. 7c schematically shows striped patterns with a varying number of sub-pixel area rows and two different sub-pixel aspect ratios,

FIG. 7d schematically shows expected banding for different sub-pixel area designs in the N=2, C=3 region.

Items which have the same reference numbers in different figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described.

For typical landscape displays, the horizontal row lines serve as address lines and the vertical column lines serve as data lines. Row lines are also referred to as address lines; their control units are called row drivers. Their control units of the vertical column lines are called column drivers. Typically a display has multiple row and column drivers, each connected with a row or column lines. The terms row line and column line are less clear for devices such as tablets that are operable in portrait and landscape mode. For this reasons, this document uses the term data line to refer to a column line and address line to refer to a row line. The terms row driver and column driver are applied similarly.

We will assume that the vertical column direction is vertical for the viewer, that is, the eyes of the viewer are aligned in the horizontal row direction.

Within the context of this document, we use the following definitions:
A ‘sub-pixel’ comprises a light-modulating element that is independently addressable, e.g., by use of at least one row line and one column line. A sub-pixel is also referred to as an addressable independent color component. Typically, a sub-pixel comprises an active matrix cell circuit. Light may be provided in response to image data, i.e., image values, received in the sub-pixel, by altering emission, reflectance, and/or transmission of light in the sub-pixel. Note that the light may be produced in the sub-pixel itself, or the light may originate in a light source external to the sub-pixel, e.g., for use in a projector such as an LCD projector. A sub-pixel is also referred to as ‘cell’. The image data may be represented digitally, especially outside the panel. For example, one way of representing an image value is as a single byte, having a range of 0-255; the 50% point of which may be selected as 127. However, in the sub-pixel, the image value may be received as an analog value, say as a voltage.
A ‘pixel’ is a smallest group of collocated sub-pixels that can produce all colors that the display is capable of producing. A pixel is also referred to as an independent full color addressable component.
A ‘smallest unit cell’, or simply ‘unit cell’, covers one or more pixels and is the smallest rectangle such that when the pixel structure in this rectangle is repeated, it creates the pixel structure of the entire display panel, regarding: color component sub-pixel types, active matrix lines and thin-film circuits. Thus when a unit cell is defined, and the dimensions of the panel are known the panel may be designed by repeating the unit cell a sufficient number of times.
A ‘sub-pixel area’ is a light-modulating element within a sub-pixel, where the light-modulating function is controlled by the active matrix sub-pixel cell circuit. A sub-pixel area is also referred to as dependent color addressable component. All sub-areas in a sub-pixel share the same image value, but two different sub-areas may respond in a different manner.

A sub-pixel with a single sub-area is referred to as monolithic. A sub-pixel may have multiple sub-areas.

For many display panels the transmission of light through a cell is viewing-angle dependent. This occurs especially in liquid crystal type display panels. For example the three main types of liquid crystal (LC) cell types that are commonly used in LC displays (LCD's). These are twisted nematic (TN), vertical alignment (VA) and in-plane switching (IPS) cells. Examples of derived technologies are multi-domain vertical alignment (MVA), patterned vertical alignment and UV photo-aligned vertical alignment (UV²A). For all these display panels, the transmission of light through a cell is viewing-angle dependent. This results in a low color performance and even grayscale inversion for TN and pure VA displays. With IPS this problem is reduced by always having LC molecules oriented parallel to the panel (in-plane). With MVA and PVA this problem is reduced by having multiple zones with different properties.

For 2D viewing, the problem is further reduced in techniques such as S-PVA and UV²A by having multiple sub-pixel areas that are driven differently. Effectively the areas have different tone response curves (gamma curves) such that the sub-areas are more often close to ON and close to OFF instead of being in a 50% grey state. Thus depending on viewing angle some zones appear brighter than others but brightness average over all zones in a pixel should be similar for a wide range of viewing angles.

Depending on the image value received in the sub-pixel, different sub-areas will turn on to a different extent. As a result, the effective shape of the sub-pixels becomes content-dependent. For autostereoscopic displays based on such panels, the amount of banding now depends on the content and is likely to be worse for low intensities where parts of the sub-pixel are off, than for high intensities where most of the sub-pixel is on.

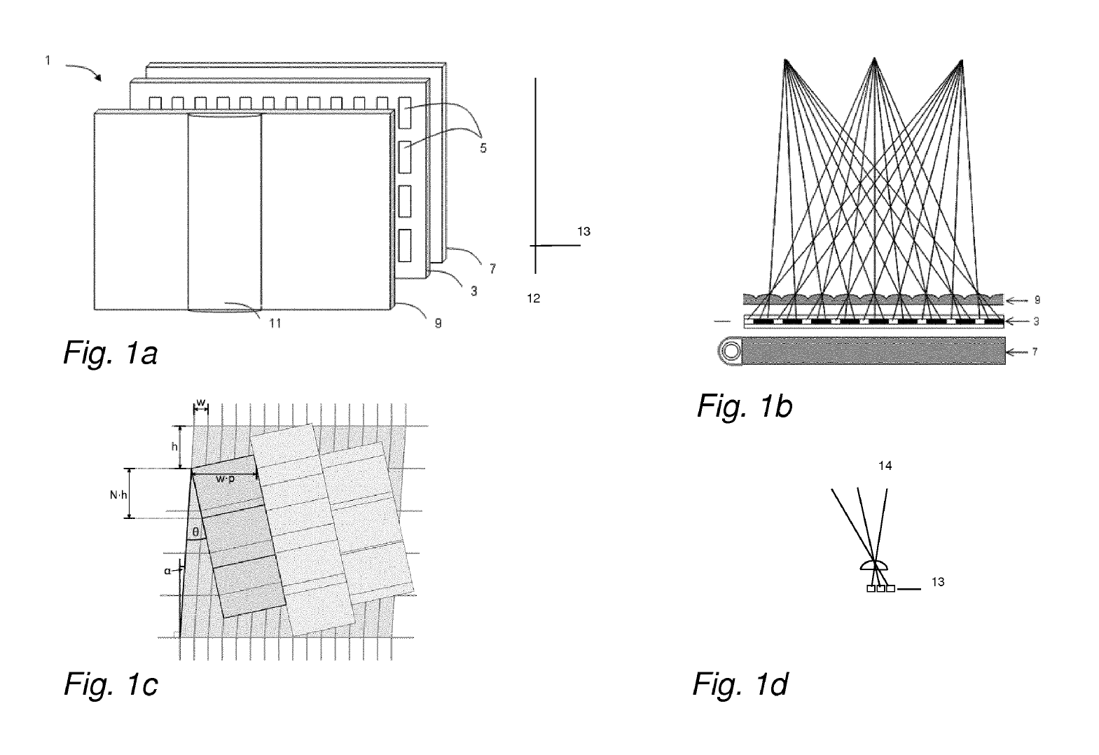

FIG. 1a is a schematic perspective view of an autostereoscopic display device. FIG. 1b is a schematic cross sectional view of the display device shown in FIG. 1a. These figures show the general mode of operation of a type of autostereoscopic display. The embodiments below disclose enhancements that may be applied in the system shown in FIGS. 1a and 1b. The autostereoscopic display 1 comprises a display panel 3. Display 1 may contain a light source 7, e.g., when the display is of LCD type, but this is not necessary, e.g., for OLED type displays.

The display device 1 also comprises a lenticular sheet 9, arranged over the display side of the display panel 3, which performs a view forming function. The lenticular sheet 9 comprises a row of lenticular lenses 11 extending parallel to one another, of which only one is shown with exaggerated dimensions for the sake of clarity. The lenticular lenses 11 act as view forming elements to perform a view forming function. The lenticular lenses of FIG. 1a have a convex side facing away from the display panel. It is also possible to form the lenticular lenses with their convex side facing towards the display panel.

The lenticular lenses 11 may be in the form of convex cylindrical elements, and they act as a light output directing means to provide different images, or views, from the display panel 3 to the eyes of a user positioned in front of the display device 1.

The autostereoscopic display device 1 shown in FIG. 1a is capable of providing several different perspective views in different directions. In particular, each lenticular lens 11 overlies a small group of display sub-pixels 5 in each row. The lenticular element 11 projects each display sub-pixel 5 of a group in a different direction, so as to form the several different views. As the user's head moves from left to right, his/her eyes will receive different ones of the several views, in turn.

Next to FIG. 1a, its column direction has been indicated at reference numeral 12.

The group of lens elements 11 is an example of a view forming system, here in the form of a lenticular, arranged with respect to the multiple sub-pixels to direct light from the sub-pixels into different angular directions with respect to row direction 13, as shown in FIG. 1b, to form the autostereoscopic image. Light is directed into either side of direction 12, for a viewer of the display who has its eyes aligned with the row direction 13.

FIG. 1d shows a detail from FIG. 1b, one lens element directs light from sub-pixels (three are shown) into different angular directions. The different directions are indicated at reference 14. The different angular directions make different angles with row direction 13.

FIG. 1c shows schematically a 3D pixel layout resulting from placing a lenticular lens with pitch p on a striped underlying display panel. FIG. 1c is an enlarged view of one 3D pixel. The figure shows a lenticular slanted with respect to a sub-pixel grid. A lenticular is an example of a view forming system comprising a group of lens elements. Autostereoscopic images may also be produced using micro lenses as lens elements instead of a lenticular.

A sub-pixel has width ‘w’ (measured in the direction of the address lines), height ‘h’ (measured in the direction of the data lines); these may be expressed in any distance metric, say meters. The sub-pixel width ‘w’ is also referred to as ‘subpx’ (for horizontal sub-pixel pitch). The sub-pixel width ‘w’ is also referred to as Δx.

For a rectangular sub-pixel, the aspect ratio ‘a’ of a sub-pixel is its width divided by its height: w/h. For a non-rectangular sub-pixel, e.g., an elliptically shaped sub-pixel, the width is defined as the length of the longest straight line segment that is contained in the sub-pixel and parallel to the row direction; and the height is defined as the length of the longest straight line segment that is contained in the sub-pixel and parallel to the column direction.

The lenticular pitch ‘p’ of the lenticular is the number of sub-pixel widths across the lens width in the direction of the address lines, i.e. (horizontal lens width)/w. The lenticular pitch is measured along the horizontal direction in units of horizontal sub-pixel pitch (w). Thus Horizontal sub-pixel pitch: w; lenticular pitch: p; lenticular pitch in meters: w·p. The lenticular pitch vector is denoted as \vec{p}.

The lenticular pitch vector is the vector which characterises the lenticular orientation and size. It is the vector from one side of the lenticular to the other side of the lenticular, perpendicularly across the lens. The pitch vector has a row direction component px and a column direction component py.

Taking the top left corner of a 3D sub-pixel, the change in height to the top right corner is wp cos θ sin θ. The change in row position is wp cos² θ. The angle θ is the angle between the column direction and the elongate lenticular direction as shown. wp cos θ is the length of the top (slanted) side of the 3D sub-pixel. This length multiplied by sin θ is the vertical component py and this length multiplied by cos θ is the horizontal component px. Taking s=tan θ gives py=pws/(1+s²) and px=pw/(1+s²).

The lenticular pitch p (expressed as the number of sub-pixel widths) need not be integer, in fact, this is typical.

As used above, the slant s is defined as the tangent of the angle θ between the lenticular and a vertical sub-pixel grid direction. The grid defines a vertical sub-pixel grid direction and a horizontal sub-pixel grid direction: the data lines are parallel to the vertical sub-pixel grid direction, and the address lines are parallel to the horizontal sub-pixel grid direction.

The figure shows a vertical sub-pixel grid direction slanted with respect to the vertical under an angle α. If α=0, then s=w/h. The latter situation corresponds to the sub-pixel grid for which the vertical sub-pixel grid direction is parallel to a side of the panel. This has the advantage that conventional LCD display panels may be used as a component. In an embodiment, α=0 and the lenticulars are parallel to a side of the panel, whereas the sub-pixel grid is slanted which respect to the side of the panel. Alignment of the lenticular is easier in this embodiment.

In general, the slant of the lenticular can be in either direction of the vertical sub-pixel grid, but the slant is still given a positive value s.

The value N is shown in FIG. 1c as the ratio of the height (in the column direction) of a 3D sub-pixel to the height of a 2D sub-pixel. Thus, the value N represents how many 2D sub-pixels contribute to each 3D sub-pixel. N is not necessarily an integer value; FIG. 1c shows a value of N slightly greater than 1.

Not all pitch (p) and slant (s) combinations are equally suitable. One region of potentially suitable designs is disclosed in WO2010070564A1, included herein by reference:

$$p = \frac{1}{2} C ( 2 N + 1 ) ( 1 + {s}^{2} ) , \\ s = \frac{1}{V ( 2 N + 1 )} ,$$

where C is the number of sub-pixel columns per pixel, N is an integer, w is the sub-pixel pitch in horizontal direction, and V is the aspect ratio of the grid formed by one sub-pixel color, in particular the grid formed by all green sub-pixels. The first equation, linking pitch to slant is referred to as preferred pitch/slant combinations.

Expressed as a pitch vector:

$$\vec{p} = [ \begin{matrix}{p}_{x} \\ {p}_{y}\end{matrix} ] = \frac{pw}{( 1 + {s}^{2} )} [ \begin{matrix}1 \\ s\end{matrix} ] = [ \begin{matrix}2 N + 1 \\ 1 / V\end{matrix} ] C / 2.$$

Note, in the latter derivation that the pitch vector is orthogonal to the optical axis. The value p is along the horizontal direction; Generally, |p|>|\vec{p}|.

For V=1 the pattern of green pixels forms a perfectly square grid, while for V=\sqrt{3} and V=1/\sqrt{3} the grid is perfectly hexagonal. Notice that the shape of the grid is determined by V and that p_{y} depends on V but not on N. Hence p_{y} describes the shape of the grid.

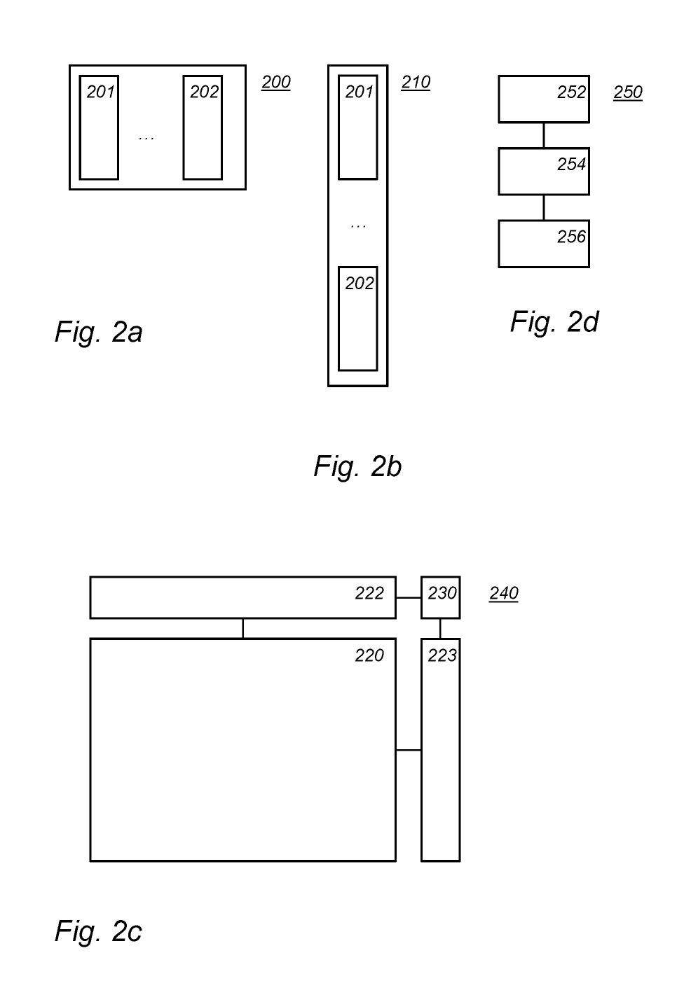

FIG. 2a schematically shows a general sub-pixel 200. Sub-pixel 200 comprises at least two sub-areas, two of which are shown: sub-areas 201 and 202. FIG. 2b schematically shows a general sub-pixel 210. Sub-pixel 210 also comprises at least two sub-areas, two of which are shown. Sub-pixels 200 and 210 differ with respect to arrangement of sub-areas within the sub-pixels. For this reason, the sub-areas in sub-pixel 210 have the same reference number. Note that details such as wiring and circuitry of the sub-pixel may be arranged differently within sub-pixels 200 and 210 to account for the different orientation of the sub-areas. The number of sub-areas in sub-pixels 200 and 210 may be 2, 3, 4, 5, 6, or even higher.

Sub-pixel 200 is split into multiple sub-areas along a direction parallel to the direction of the columns; For example, Sub-pixel 200 is divided into multiple sub-areas along one or more dividing lines that are parallel to the column direction. Sub-pixel 210 is split into multiple sub-areas along a direction parallel to the direction of the rows; For example, Sub-pixel 210 is divided into multiple sub-areas along one or more lines that are parallel to the row direction. In an embodiment, the sub-pixels (200) are split in the multiple sub-areas along a direction parallel to the direction of the columns, so that the aspect ratio of the sub-areas is smaller than the aspect ratio of the sub-pixel.

Although the direction of rows and columns are often perpendicular, this is not needed. In that case a sub-pixel may still be split parallel to the row or column direction, but may also be split parallel to the side of the display panel, etc.

FIG. 2c schematically shows a display system 240 including a display panel 220. Display panel 220 comprises multiple sub-pixels, say sub-pixel 200 or sub-pixel 210, arranged in rows and columns. Sub-pixels are arranged for a set of colors, say red, green and blue. Display panel 220 arranges sub-pixels of different colors in a pattern, say rgb-striped.

Display panel may further comprise data (column) drivers 222, address (row) drivers 223 and an image source 230. To form an autostereoscopic display system, a view forming system is applied to display panel 220. The view forming system is not shown in FIG. 2c. The view forming system comprises a group of lens elements. The lens elements are arranged with respect to the multiple sub-pixels of display panel 220 to direct light from the sub-pixels into different angular directions to form the autostereoscopic image.

Image source 230 may digitally store images for autostereoscopic viewing, i.e., a digital map indicating one or more image values, i.e., image data for each of the sub-pixels. The image data may be stored in an electronic memory comprised in image source 230. Image source 230 may represent image data in the form of a byte per sub-pixel. More of fewer than 8 bits per sub-pixels is possible, say 6, or 10. Data drivers 222 may represent the image data in analog form, say as a voltage.

Typically, the display system 240 comprise a microprocessor (not shown) which executes appropriate software stored, e.g. at image source 230.; for example, that software may have been downloaded and/or stored in a corresponding memory, e.g., a volatile memory such as RAM or a non-volatile memory such as Flash (not shown). Alternatively, the system may, in whole or in part, be implemented in programmable logic, e.g., as field-programmable gate array (FPGA). The system may be implemented, in whole or in part, as a so-called application-specific integrated circuit (ASIC), i.e. an integrated circuit (IC) customized for their particular use.

The image source may comprise a processor circuit and storage circuit, the processor circuit executing instructions represented electronically in the storage circuits. The circuits may also be FPGA, ASIC or the like. The data and address drivers may comprise data and address driving circuits.

Returning attention to FIGS. 2a and 2b. Sub-pixels 200 and 210 are arranged to provide light according to an image value received in the sub-pixel, e.g. from the data drivers. The multiple sub-areas in the sub-pixel respond to the received image value, e.g., by modulating light according to the image value that was received in the sub-pixel. However, not all sub-areas need to respond in the same way, i.e., need to provide light of the same intensity for all possible image values. In particular, at least two of the multiple sub-areas in a sub-pixel are arranged, say sub-pixels 201 and 202, to provide light of a different intensity for at least one image value received in the sub-pixel.

Light intensity may be measured using any light intensity measurement system suitable for televisions, e.g., the luminous intensity directly at the output of a sub-pixel, but after possibly layers or coating applied to the sub-pixel; the luminous intensity may be measured in candela.

We will refer to one sub-area of the multiple sub-areas of a sub-pixel as a low-gamma sub-area. A low-gamma sub-area is a high-intensity sub-area.

In the low-gamma sub-area the light intensity in response to an image value representing a midpoint of an image value range is maximum for all sub-areas in the sub-pixel. If the range has even length, an arbitrary selection of the two midpoints may be made. In other words, given an image value range of 256 values, when the sub-pixel receives image value 127, the low-gamma sub-area responds with the most intensity. In an embodiment, this low-gamma sub-area is unique in the sub-pixel.

In an embodiment, there may be multiple low-gamma sub-areas according to this definition. In this case, to further reduce the low-gamma sub-areas, we may define the low gamma sub-area as follows: In the low gamma sub-area the light intensity in response to any image value is at least as high as for any other sub-areas in the sub-pixel. Also according to this definition there may be multiple low-gamma sub-areas in a sub-pixel.

The high-gamma area of a sub-pixel is defined similarly, but for minimum intensity.

The term high and low gamma originates from the term gamma curve. A gamma curve is a possible tone response curve that indicates how a sub-area produces an intensity in response to receiving an image value. The parameter gamma indicates the shape of the curve. Indeed it is possible that sub-areas have a gamma response curve corresponding to a particular value of gamma. However, this particular shape is not necessary, as shown below.

In an embodiment, the low gamma sub-area is at the same position in the sub-pixel, the low-gamma sub-areas thus forming a low-gamma sub-area line extending in the row or column of sub-pixels.

For example, in an embodiment, a low gamma sub-area in a sub-pixel is arranged among the multiple sub-areas of that sub-pixel at a position furthest to the left or to the right, i.e., along the direction of the rows of the display panel, or at a position furthest to the top or to the bottom, i.e., along the direction of the columns of the display panel.

This position implies that the low gamma areas form connected lines, either in the column or row direction. Such lines, as opposed to a checkerboard type distribution in which the position of the low gamma sub-area alternates between two positions in the sub-pixel, have fewer problems with banding in autostereoscopic display system, especially at relevant slants. If the number of sub-areas is three or higher, however, the checkerboard pattern gives acceptable banding. The effects are strongest if the arrangement of the sub-pixel is applied to all sub-pixels in the panel.

The same may be done for the high-gamma area. In an embodiment, both the low and high gamma sub-areas are connected in the column or row direction. The low-gamma sub-areas forming low-gamma lines, i.e., high-intensity lines.

Furthermore, the number sub-areas may be three. The latter implies that all sub-areas are aligned, i.e., low, high but also a middle gamma sub-area.

In an embodiment, the low and/or high gamma area form connected lines in the column (in case of sub-pixel 200) or in the row direction (in case of sub pixel 210), and moreover these lines have the same color. For example, in case of sub-pixel 200, the sub-pixels in the same column of the display may provide light of the same color.

If there are more than two sub-areas per sub-pixel, it does not necessarily have to be that either the top area or the bottom area is the low-gamma sub-area. In an embodiment, there are more than two sub-areas per sub-pixel, and the low gamma sub-area is at the same position in the sub-pixel one for each sub-pixel.

In an embodiment, the at least two of the multiple sub-areas in a sub-pixel having a different response are adjacent. In an embodiment, the high and low gamma areas are adjacent.

In an embodiment, any one of the multiple sub-areas of a sub-pixel are arranged to provide light of one of two different intensities for at least one image value received in the sub-pixel. In this embodiment, each sub-area is either a low or a high gamma area.

In an embodiment, the multiple sub-areas have a rectangular shape, wherein the ratio between a short side of the rectangle and a long side of the rectangle is more than 2/3.; in an embodiment more than 3/4. It has further been found that sub-areas are preferably, close to being square, as this will result in higher display brightness. Splitting parallel to the column direction makes the sub-areas more narrow, which is advantageous to reduce banding. Splitting parallel to the row direction makes the sub-areas less narrow, e.g., closer to being square, which improves panel brightness.

FIG. 2d schematically shows in the form of a flow chart an autostereoscopic display method 250 to display an autostereoscopic image. Method 250 comprises

Receiving 252 an image value in sub-pixels of a display panel. The display panel comprises multiple sub-pixels arranged in rows and columns, the sub-pixels comprising multiple sub-areas. Preferably, all sub-pixels comprise multiple sub-areas.

Providing 254 light according to the image value received in a sub-pixel. The providing comprises providing light of a higher intensity in a high-intensity sub-area of the multiple sub-areas than the other sub-areas of the sub-pixel for at least one image value received in the sub-pixel.

Directing 256 light from the sub-pixels into different angular directions with respect to the row direction thus forming the autostereoscopic image.

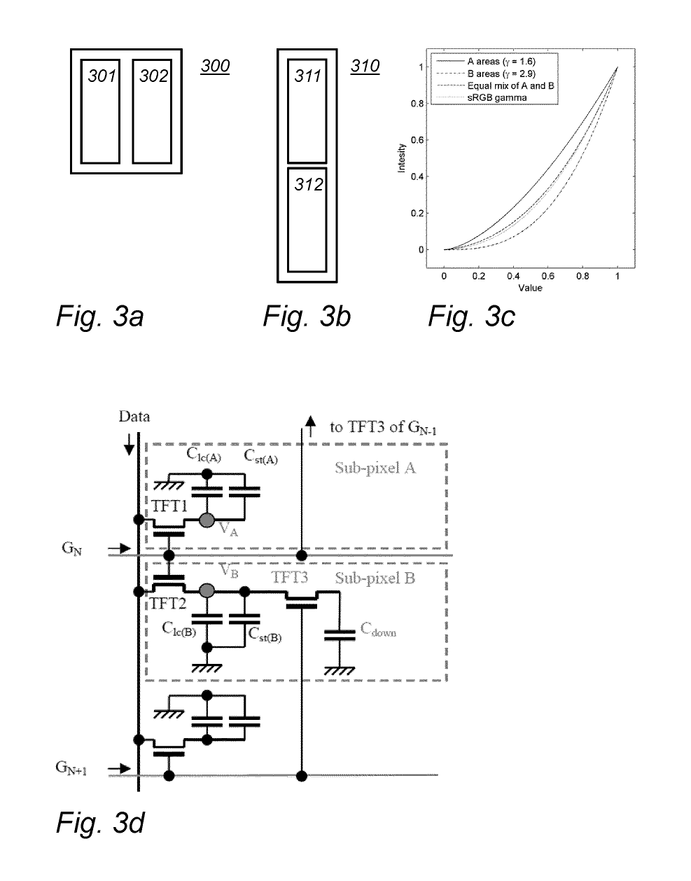

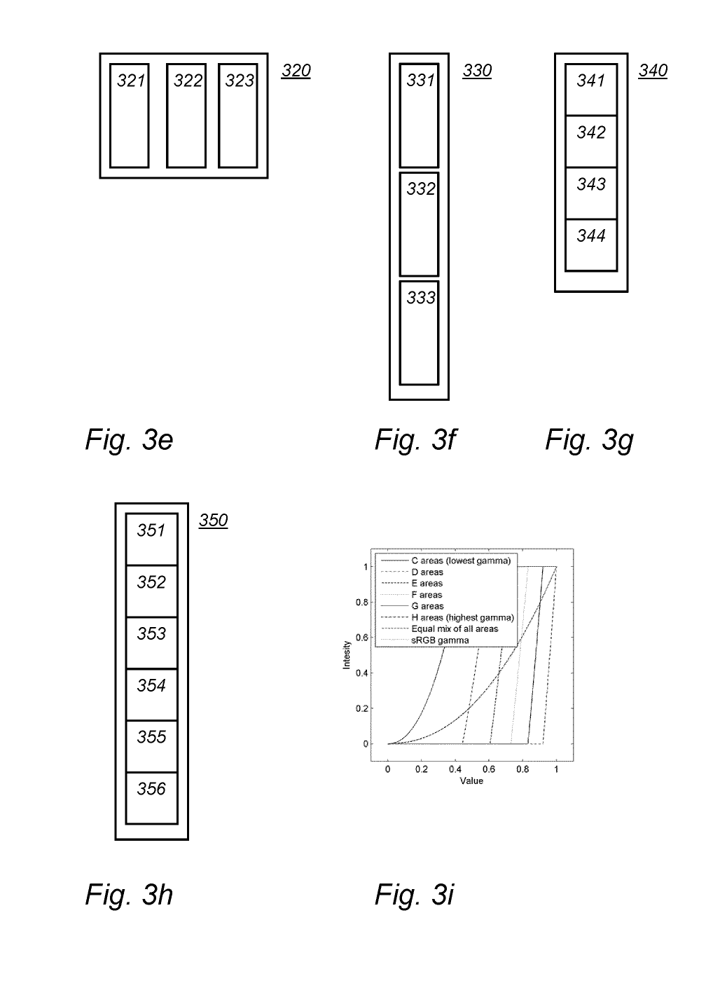

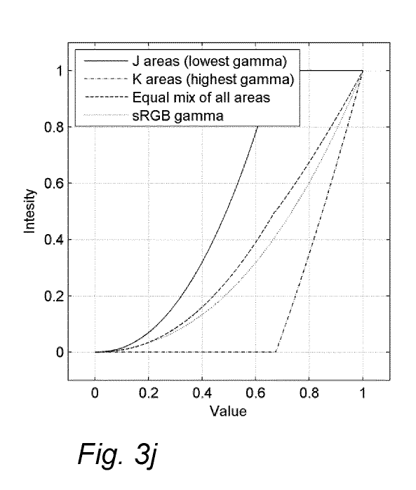

FIG. 3a shows a sub-pixel 300 having two sub-areas 301 and 302. Sub-pixel 300 is divided into two sub-areas along a line parallel to the column direction. This division is beneficial in striped displays, in which the stripe direction is parallel to the column direction, e.g., RBG striped. An advantageous slant for the lenticular for sub-pixel 300 is between 0.3*a and 0.75*a, wherein a is the sub-pixel aspect ratio.

FIG. 3b shows a sub-pixel 310 having two sub-areas 311 and 312, divided parallel to the row direction. This division is beneficial in striped displays, in which the stripe direction is parallel to the row direction.

FIG. 3c shows possible tone response curves for areas 301 and 302, or 311 and 312, (areas A and B) in this case gamma curves.

FIG. 3d shows a possible circuit for sub-pixels 300 and 301. Shown is a data line, on which the image data is received, and address lines G N and G N+1.

FIG. 3e shows a sub-pixel 320 with three sub-areas, 321, 322, and 323.

FIG. 3f shows a sub-pixel 330 with three sub-areas, 331, 332, and 333.

FIG. 3g shows a sub-pixel 340 with four sub-areas, 341, 342, 343 and 344.

FIG. 3h shows a sub-pixel 350 with six sub-areas, 351, 352, 353, 354, 355 and 356.

FIG. 3i shows possible tone response curves for areas 351, 352, 353, 354, 355 and 356 (Areas C, D, E, F, G and H). In this case the tone response curves are not gamma curves. Nevertheless, the mix of low- and high-gamma areas corresponds to sRGB.

FIG. 3j shows possible tone response curves for two areas (Areas J and K) for use in any sub-pixel with two sub-areas. In this case the tone response curves are not gamma curves. Nevertheless, the mix of low- and high-gamma areas corresponds to sRGB, although the approximation is less close than with 6 sub-areas.

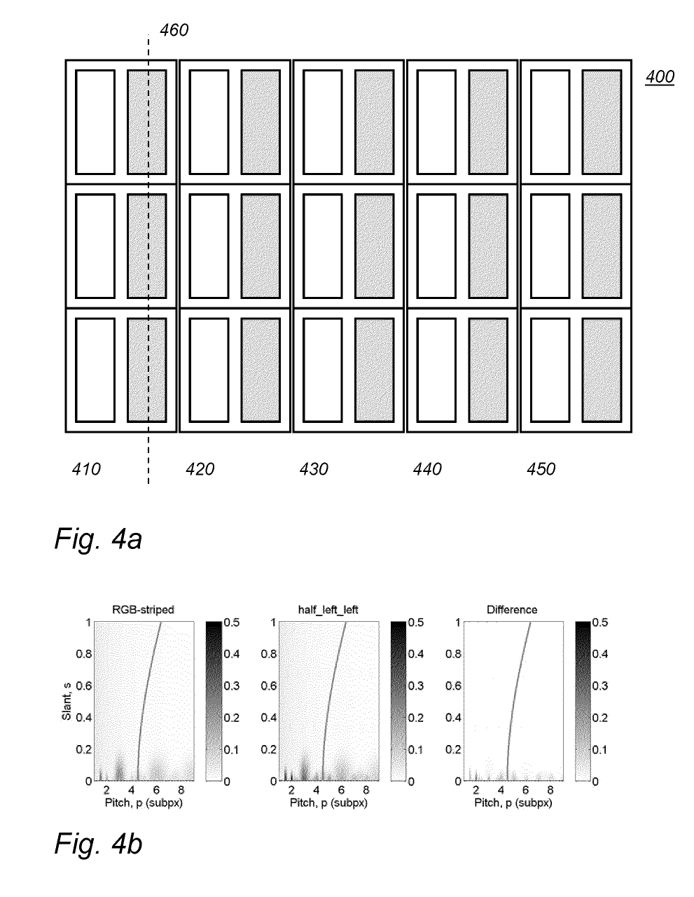

FIG. 4a schematically shows part of display panel 400, i.e., a possible arrangement of sub-pixel 300 in a display panel. The display panel is shown with perpendicular columns and rows. Each sub-pixel has a high gamma and a low gamma area. The low-gamma area has been indicated as shaded, and is always at the same position in the sub-pixel; in this case at the far right. The low-gamma areas form lines in the column direction extending over the display panel. One of the lines has been indicated at 460.

Thus the sub-pixels are driven so to that in each sub-pixel the same area turns on first, e.g. all the right parts of the sub-pixels.

In general, splitting of the sub-pixel areas more perpendicular than parallel to the color modulation produces less banding. (i.e. in a RGB-striped pixel design, vertical splitting of a sub-pixel is better than a horizontal splitting). Display panel 400 may have columns 410, 420, 430 440 and 450; Sub-pixels in these columns may represent, red, green, blue, red, green, . . . , etc. The direction of the so-called color-modulation is the dominant direction in which the colors of the sub-pixels change. For a striped color modulation design, the direction of the color modulation is perpendicular to the stripes.

With such a sub-pixel area design, any added banding due to sub-area driving will be mostly seen for lens designs that also show banding when all the areas are on, thus little banding is added by the sub-areas compared to monolithic designs. For lens designs which are favorable for good 3D performance the added banding is minimal.

FIG. 4b shows an overview of the amount of visible banding as a function of the slant and the pitch of the lens is given. In the left panel we see the banding for a regular RGB-striped panel, in the center panel the banding for vertical splitted sub-pixels, and in the right panel the difference between the two to indicate the extra added banding due to the sub-pixel areas. The grey line indicates the preferred pitch/slant combination defined above. Slant values larger-or-equal than a (the aspect ratio of a sub-pixel) and/or smaller-or-equal than 1/2a are particularly advantageous for reducing banding.

For an aspect ratio of 1/3, Slant values larger-or-equal than 1/6 and/or smaller-or-equal than 1/3 are particularly advantageous. The 1/2a boundary is soft, and maybe extended to, say, 3a/8, with increasing loss of quality. In case of an aspect ratio of 1/3, about 1/7 is also acceptable.

Within this interval, a lens elements slant (s) to the direction of the columns of between 0.30 times the sub-pixel aspect ratio (0.3*a) and 0.75 times the sub-pixel aspect ratio (0.75a) is a particularly advantageous selection with little banding, providing reduced viewing angle dependency and autostereoscopic quality.

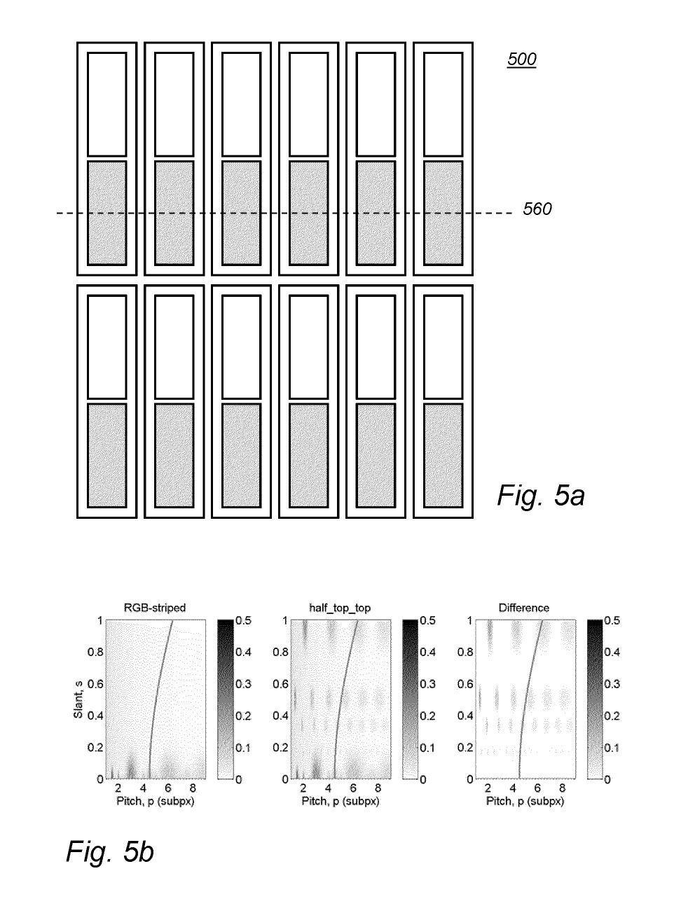

FIG. 5a schematically shows part of display panel 500, a possible arrangement of sub-pixel 310 in a display panel. The display panel is shown with perpendicular columns and rows. Each sub-pixel has a high gamma and a low gamma area. The low-gamma area has been indicated as shaded, and is always at the same position in the sub-pixel; in this case at the far bottom. Thus the sub-pixels are driven such to that in each sub-pixel the same area turns on first, e.g. all the bottom parts of the sub-pixels. The low-gamma areas form lines in the row direction extending over the display panel; One of these lines has been indicated at 560.

FIG. 5b shows a plot with expected banding as a function of pitch and slant for (left) a regular RGB-striped panel and (center) a horizontally splitted sub-pixel area design (panel 500) where the same areas are driven in a similar way. On the right we see the difference between the two, highlighting the lens design areas where extra banding is expected.

Although this design does not place the splitting of the sub-pixel areas more perpendicular than parallel to the color modulation, nevertheless for low slants (smaller than the aspect ratio a, say less than 1/3) the added banding is small. A lens elements slant (s) to the direction of the columns of less than 0.75 times the sub-pixel aspect ratio (0.75a) is particular advantageous against banding.

For higher slants there are certain pitch values for which the added banding is significant.

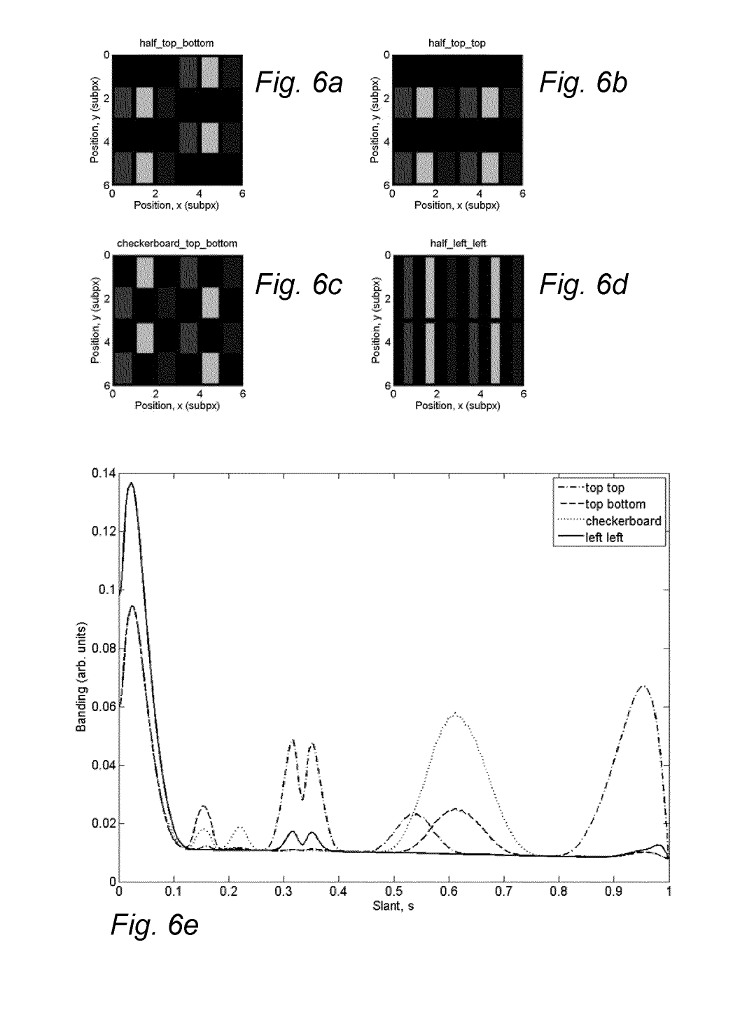

FIG. 6a shows an arrangement in which sub-pixels are horizontally split into two sub-areas. The position of the low-gamma sub-area is the same within each sub-pixel, but follows the checkerboard pattern across pixels. Thus in a pixel all low-gamma areas are at the bottom, in a next pixel, adjacent in the same row or column, all low-gamma areas are at the top. This design is referred to as half_top_bottom or just_top_bottom.

FIG. 6b shows the pattern of panel 500. This design is referred to as half_top_top or just_top_top.

FIG. 6c shows a checkerboard design. In each sub-pixel the low-gamma areas is at a different position than, in a next sub-pixel, adjacent in the same row or column. This design is referred to as checkerboard_top_bottom or just checkerboard.

FIG. 6d shows the pattern of panel 400. This design is referred to as as half_left_left or just_left_left.

In FIG. 6d, the sub-pixel is divided into two sub-pixels along a dividing line parallel to the column direction. In FIGS. 6a-c, the sub-pixel is divided into two sub-pixels along a dividing line parallel to the row direction.

In FIGS. 6a-6d the display is driven at 50% grey. Half the sub-areas in a sub-pixel provide light and half do not.

FIG. 6e shows expected banding for different sub-pixel area designs as a function of lens design. The lens design is indicated here only by the slant. The corresponding pitch can be calculated from the equation p=1/2C(2N+1)(1+s²). From these simulations it can be seen that the sub-pixel area design has a large influence on the expected banding. For example, lens designs with a slant between 1/9^{th} and 1/4^{th}, a layout with a vertical splitting of the sub-pixel and similar driving of all the left and all the right parts gives almost no banding.

Banding is presented in arbitrary units, based on a model of the contrast sensitivity of the human visual system. The model includes, amongst others, simulating a 3D display with a lenticular indicated by the pitch and slants for a 50% grey image and performing a 2D Fourier transform. Note, that in embodiments, some variation from the pitch and slant indicated by the preferred combination formula is designed in, as some exact values of pitch and slant may be harder to produce. This does not deter from the general guidelines of the design given herein.

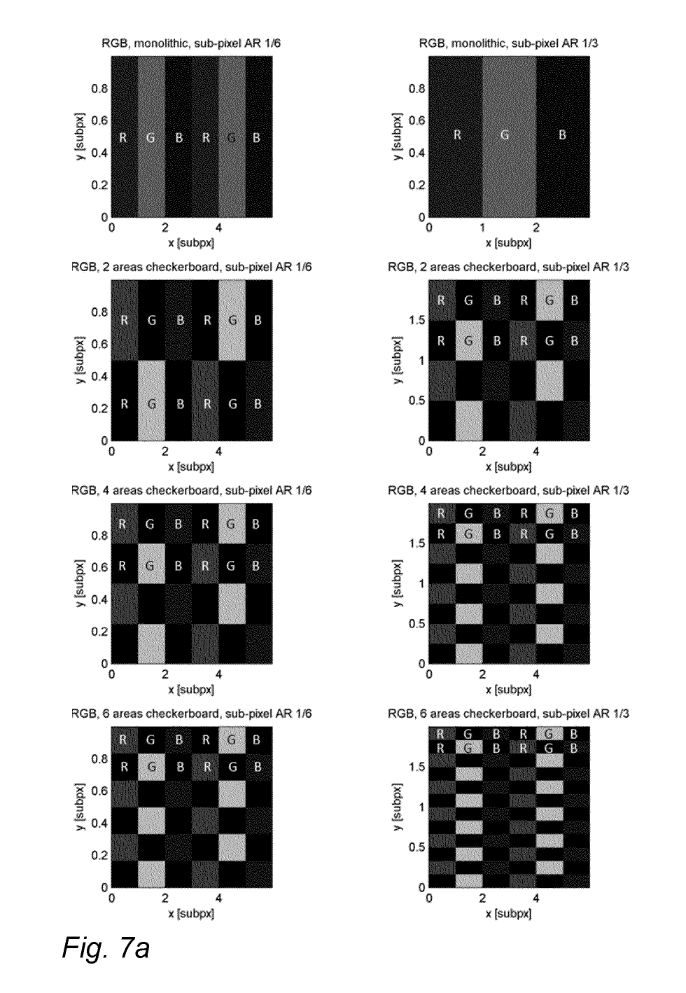

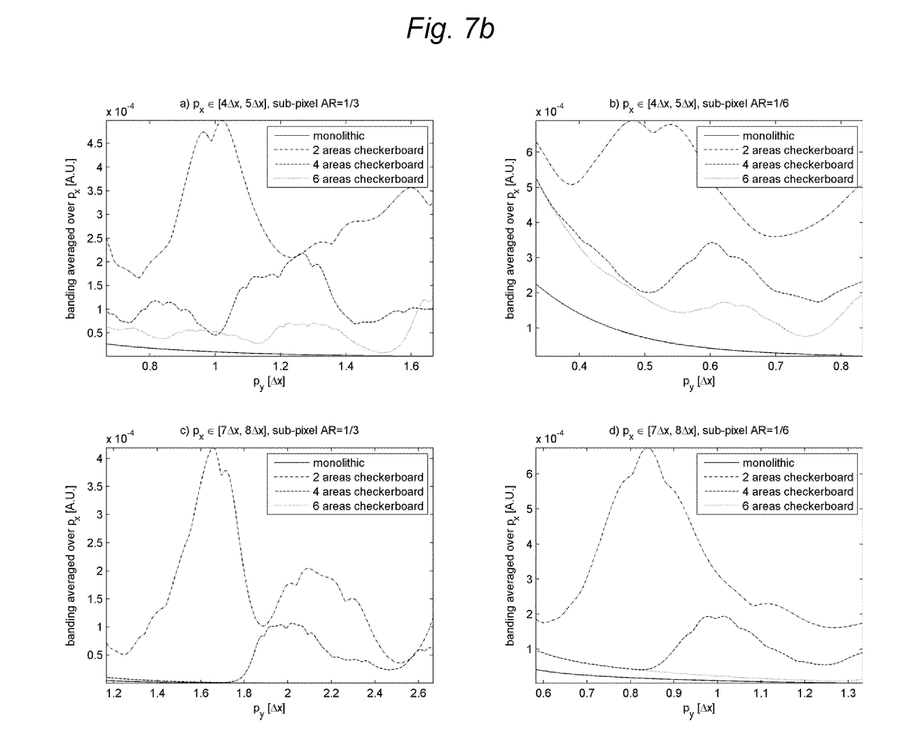

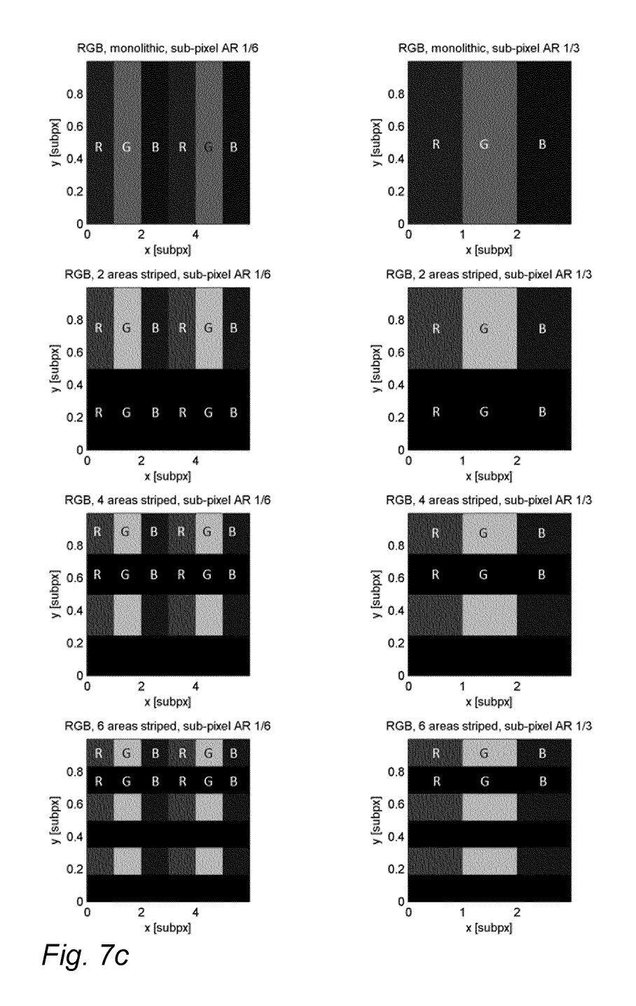

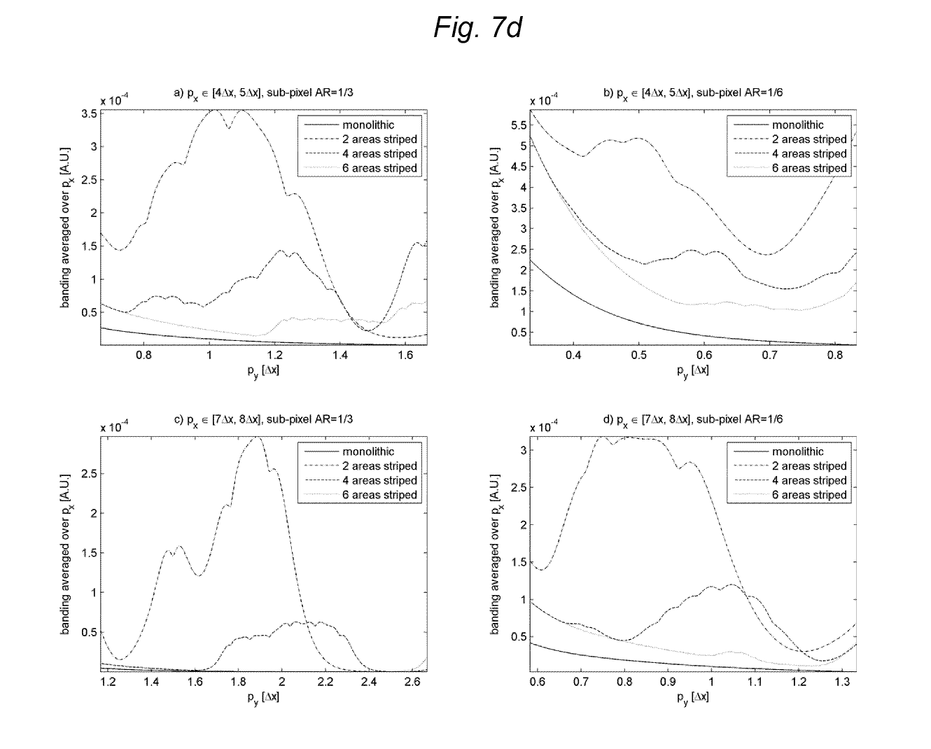

FIGS. 7a and 7b explore various design options for sub-pixels with two or more sub-areas. For comparison also a monolithic design is included. FIG. 7a shows checkerboard patterns with a varying number of sub-pixel area rows and two different sub-pixel aspect ratios. FIG. 7b shows the corresponding expected banding for different sub-pixel area designs in the N=1, C=3 region that is defined by the equations above. The lens design is indicated here only by the y-component of the pitch vector. The experiments shown here focus on the checkerboard pattern that is known to give a lot of banding compared to a monolithic design. When we increase the number of rows of sub-pixel areas (FIG. 7a), while maintaining the checkerboard grid, then our simulations showed a strong reduction in banding in the relevant parameter range (FIG. 7b).

FIG. 7c shows striped patterns with a varying number of sub-pixel area rows and two different sub-pixel aspect ratios. FIG. 7d shows expected banding for different sub-pixel area designs in the N=2, C=3 region that is defined by equations above. The lens design is indicated here only by the y-component of the pitch vector.

In the experiments shown in FIGS. 7a-7d suitable parameter range for the banding simulation were selected based on reasonable criteria. The pitch vector x-component is placed in a region around the optimal value. The N=1 region is suitable for autostereoscopic displays (ASD) based on ultra-high definition (UHD, also known as 4K) panels while the N=2 region is more suitable for Super Hi-Vision (SHV, also known as 8K) panels. Based on manual observations we have selected a [−1/2, 1/2] range around the optimal pₓ value, giving

pₓεPₓ=[1/2C(2N+1)−1/2,1/2C(2N+1)+1/2].

Substituting C=3 for three primary colors this simplifies to

pₓεPₓ=[3N+1,3N+2].

Having a very small slant balances the spatial vs. angular resolution trade-off too much in the angular direction so we selected a slant lower limit of half of the sub-pixel aspect ratio (SPAR). Having a slant that is bigger than the sub-pixel aspect ratio is unwise because too much angular resolution is sacrificed. We therefore select [1/2a,a] as a suitable slant range where a denotes the sub-pixel aspect ratio (SPAR). Applying the property p_{y}=spₓ this translates to

p_{y}εP_{y}=[1/2a inf(Pₓ),a sup(Pₓ)].

Combining these formulas and for the sub-pixel aspect ratio a value 1/3, we obtain

p_{y}εP_{y}=[1/2N+1/6,N+2/3].

Note that the invention is not limited to this set of regions. They are selected because they cover a wide range of known or anticipated lenticular designs, and allow illustration of the principals of operation illustrated in the designs and graphs of FIGS. 7a-7d.

In FIG. 7b the expected banding is plotted for a different number of sub-pixel areas, values of N and sub-pixel aspect ratios. The following is particularly observed:
For monolithic pixels without black matrix there is virtually no banding.
For the checkerboard grid that has two sub-pixel areas per sub-pixel there is severe banding within a large part of the relevant parameter range.
For more sub-areas per sub-pixel the region of severe banding moves towards higher p_{y} and slant values.
For three areas (not shown in figure) there may still be significant banding but this is already a good solution for designs in which slant s is between a and 1/2a, and vertically RGB-striped. In an embodiment, α=1/3 and slant s is within [1/6, 1/3].
Increasing amount of areas (e.g. 4 and 6) gives a gradual improvement:
   Having four areas is much better than three areas.
   With six areas banding is largely eliminated.

In each of the experiments we have set the visual angle of a lenticular lens to be 30 arcsec (145 μrad) such that a 2D image that would be rendered on the display would not appear pixelated with 20/20 vision. The limit for human vision is 60 arcsec per line pair on average. We then simulated the banding and computed the visibility of the banding based on a model of the contrast sensitivity of the human visual system.

In FIGS. 7a and 7c, all sub-pixels that are divided into multiple sub-areas (non-monolithic sub-pixels), are divided along a dividing line parallel to the row direction. For all sub-pixels in one row, the sub-areas are indicated with a letter. The letter indicates a possible color modulation scheme.

The non-monolithic sub-pixels are shown in the 50% grey state. In FIG. 7c, this shows as black bars that extend in the row direction. In FIG. 7a this shows as a checkerboard pattern of black sub-areas.

Two examples with additional benefits are: Multiple identically driven sub-areas e.g. ABABA B . . . has the benefit that the amount of transistors and capacitors can be kept minimal. For example, sub-pixels with 4 or 6 sub-areas in which each sub-area has one of two different tone response curves, e.g. as indicated in FIG. 3c. Another possibility is that all areas have a different tone response curve, e.g., as illustrated in FIG. 3i. However, in which the response curve have sharp onsets, with all onsets different and mixed, e.g., C F G D H E . . . .

For example, a sub-area with a sharp onset, may have a low-onset value and a high-onset value. For an image value below the low-onset value the sub-area does not respond; for an image value above the high-onset value the sub-area responds maximally. Between the low and high-onset values the sub-area increases intensity as the image value increases, for example, linearly. In an embodiment of a sharp-onset sub-area, the difference between the low and high-onset value is less than 20% of the image value range; in an embodiment, the different is less than 10%. FIG. 3i shows 5 sharp onset curves (areas D, E, F, G and H) in which the difference between low and high onset is 10%. For an image range of 256 different values, this means that all variation occurs for (say) 25 different image values, for the remaining image values the response is either maximal or minimal. In an embodiment, a sub-pixel has at least one sub-area with a sharp-response. Sharp onset sub-areas reduce angular viewing dependency. In an embodiment, all but one of the sub-areas in a sub-pixel have a sharp-response. Having, a sub-area that is not sharp-onset makes it easier to approximate a given response curve with the average response of the sub-areas. The one non-sharp response can be freely tuned. For example, this is desirable to approximate the sRGB response. In an embodiment, all sub-areas in a sub-pixel have a sharp-response. If the number of sub-areas is larger a good approximation can be obtained using only sharp-response sub-areas, say if the number of sub-areas is 6 or larger, or even 8 or larger.

The inventors have found earlier that elongated sub-pixels are advantageous for autostereoscopic displays, for example the aspect ratio of the sub-pixels may be less-or-equal than 1/3, for example, less-or-equal than 1/6, or even less-or-equal than 1/9. For elongated sub-pixels or for higher numbers of sub-areas, say 3 or more, say 4 or more, it is advantageous to have squarer sub-areas.

In general there is an area between sub-pixel areas with different liquid crystal orientation—called a line of disclination—which appears as a dark band. This both reduces the panel brightness (by reducing the aperture ratio) and generates potential additional causes of banding (as it is effectively extra black matrix). For most display technologies it is difficult to have very long and thin sub-pixel areas and the highest aperture given a number of areas would be obtained by making the areas as square as possible. Splitting in horizontal direction makes the sub-pixels more square for elongated sub-pixels. In general a solution with a more square sub-pixel area of a given gamma will be a preferred solution, as this results in a minimum area of disclination lines for a given bright pixel area. In an embodiment, the multiple sub-areas have a rectangular shape, wherein the ratio between a short side of the rectangle and a long side of the rectangle is more than 2/3. Furthermore, the number of sub-areas may be 3 or larger.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. An autostereoscopic display system arranged to display an autostereoscopic image, the display system comprising:
a display panel, the display panel comprising multiple sub-pixels,
wherein the sub-pixels are arranged in rows and columns,
wherein the columns extend across the panel in a column direction,
wherein the rows extend across the panel in a row direction,
wherein the sub-pixels are arranged to provide light according to an image value received in the sub-pixel,
wherein the sub-pixels comprise multiple sub-areas,
wherein each sub-area of the sub-pixel is arranged to provide light according to the image value received in the sub-pixel,
wherein the multiple sub-areas of a sub-pixel comprise a high-intensity sub-area,
wherein the high-intensity sub-area is arranged to provide light of a higher intensity than the other sub-areas for at least one image value received in the sub-pixel; and
a view forming system comprising a group of lens elements, wherein the lens elements are arranged to direct light from the sub-pixels into different angular directions with respect to the row direction to form the autostereoscopic image,
wherein the sub-pixels are split into the multiple sub-areas by dividing lines,
wherein the dividing lines are arranged in a direction parallel to the column direction, such that the multiple sub-areas are arranged along the row direction.

2. The autostereoscopic display system of claim 1,
wherein the light intensity of the high-intensity sub-area is higher than the other sub-areas in the multiple sub-areas of a sub-pixel in response to an image value representing a midpoint of an image value range,
wherein along the sub-pixels of a column of the display panel the high-intensity sub-areas are at the same position in the sub-pixel,
wherein the high-intensity sub-area are arranged to form a high-intensity sub-area line extending in the column of sub-pixels.

3. The autostereoscopic display system of claim 1, wherein the high-intensity sub-area in a sub-pixel is arranged at a first or last position along the row direction in the sub-pixel.

4. The autostereoscopic display system as in claim 1, wherein sub-pixels in the same column of the display provide light of the same color.

5. The autostereoscopic display system as in claim 1,
wherein the lens elements comprise lenticular lenses,
wherein the lenticular lenses have long axis and short axis,
wherein the lenticular lenses have a slant relative to the column direction,
wherein the slant is between 0.30 times the sub-pixel aspect ratio and 0.75 times the sub-pixel aspect ratio,
wherein the slant comprises the tangent of the angle between the column direction and the long axis.

6. The autostereoscopic display system as in claim 1,
wherein the multiple sub-areas of a sub-pixel comprise at least three different sub-areas, or
wherein the multiple sub-areas of a sub-pixel comprise at least four different sub-areas, or
wherein the multiple sub-areas of a sub-pixel comprise at least six different sub-areas.

7. The autostereoscopic display system as in claim 1,
wherein each one of the multiple sub-areas of a sub-pixel is arranged to provide light of either a first intensity or of a second light intensity for at least one image value received in the sub-pixel,
wherein the first and second intensity are different.

8. The autostereoscopic display system as in claim 1, wherein the light intensities of all sub-areas of all sub-pixels of the display panel in response to an image value representing a midpoint of an image value range form a checkerboard pattern.

9. The autostereoscopic display system as in claim 1, wherein the aspect ratio of the multiple sub-areas is more than 2/3.

10. The autostereoscopic display system as in claim 5, wherein the slant is larger-or-equal than 1/6 and/or smaller-or-equal than 1/3.

11. A display panel for an autostereoscopic display system comprising:
multiple sub-pixels, the multiple sub-pixels arranged in rows and columns,
wherein the sub-pixels are arranged to provide light according to an image value received in the sub-pixel,
wherein the sub-pixels comprise multiple sub-areas,
wherein each sub-area of the sub-pixel are arranged to provide light according to the image value received in the sub-pixel,
wherein at least two of the multiple sub-areas in a sub-pixel are arranged to provide light of a different intensity for at least one image value received in the sub-pixel,
wherein the sub-pixels are split into the multiple sub-areas by dividing lines,
wherein the dividing line are arranged in a direction parallel to the column direction,
wherein the multiple sub-areas are arranged in along the row direction.

12. A method of displaying an autostereoscopic image, the display method comprising:
receiving an image value in sub-pixels of a display panel, the display panel comprising multiple sub-pixels,
wherein the multiple sub-pixels are arranged in rows and columns,
wherein the columns extends across the panel in a column direction,
wherein the rows extends across the panel in a row direction,
wherein each of the sub-pixels comprise multiple sub-areas,
wherein each of the sub-pixels are split into the multiple sub-areas by dividing lines,
wherein the dividing lines are aligned in a direction parallel to the column direction,
wherein the multiple sub-areas are arranged along the row direction;
providing light according to the image value received in a sub-pixel, wherein the providing comprises providing light of a higher intensity in a high-intensity sub-area, wherein the high-intensity sub-area emits light higher than that of the other sub-areas of the sub-pixel, for at least one image value received in the sub-pixel; and
directing light from the sub-pixels into different angular directions with respect to the row direction, wherein the directed light forms the autostereoscopic image.

13. The display panel of claim 11,
wherein the light intensity of the high-intensity sub-area is higher than the other sub-areas in the multiple sub-areas of a sub-pixel in response to an image value representing a midpoint of an image value range,
wherein along the sub-pixels of a column of the display panel the high-intensity sub-areas are at the same position in the sub-pixel,
wherein the high-intensity sub-area are arranged to form thus a high-intensity sub-area line extending in the column of sub-pixels.

14. The display panel of claim 11, wherein the high-intensity sub-area in a sub-pixel is arranged at a first or last position along the row direction in the sub-pixel.

15. The display panel of claim 11, wherein sub-pixels in the same column of the display provide light of the same color.

16. The display panel of claim 11,
wherein the lens elements comprise lenticular lenses,
wherein the lenticular lenses have long axis and short axis,
wherein the lenticular lenses have a slant relative to the column direction,
wherein the slant is between 0.30 times the sub-pixel aspect ratio and 0.75 times the sub-pixel aspect ratio,
wherein the slant comprises the tangent of the angle between the column direction and the long axis.

17. The display panel of claim 1,
wherein each one of the multiple sub-areas of a sub-pixel is arranged to provide light of either a first intensity or of a second light intensity for at least one image value received in the sub-pixel,
wherein the first and second intensity are different.

18. The method of claim 11,
wherein the light intensity of the high-intensity sub-area is higher than the other sub-areas in the multiple sub-areas of a sub-pixel in response to an image value representing a midpoint of an image value range,
wherein along the sub-pixels of a column of the display panel the high-intensity sub-areas are at the same position in the sub-pixel,
wherein the high-intensity sub-area are arranged to form a high-intensity sub-area line extending in the column of sub-pixels.

19. The method of claim 12, wherein the high-intensity sub-area in a sub-pixel is arranged at a first or last position along the row direction in the sub-pixel.

20. The method of claim 12, wherein sub-pixels in the same column of the display provide light of the same color.
